(19) United States
(12) Patent Application Publication
(10) Pub. No.: US 2006/0033744 A1
(43) Pub. Date: Feb. 16, 2006

(54) Device and method for continuous screen updates in low-power mode

(75) Inventor: Ricardo Martinez Perez, Plantation, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 10/917,743

(22) Filed: Aug. 13, 2004

(51) Int. Cl. G06F 15/16

(52) U.S. Cl. 345/502

(57) ABSTRACT

A portable device with a processor, direct memory access controller, display controller, a display, and a low power mode. Wherein the device receives recipe information, which includes data, and instructions on how the data should be displayed on the display, as well as how often to replace the data with new data, and how often to repeat the data cycle. The processor creates a recipe from the recipe information, stores the recipe in memory and enters a low-power mode. While the processor is in low-power mode, the direct memory access controller can process the recipe and cause the data to be displayed on the display according to the recipe instructions. Alternatively, with the processor in low-power mode, the display controller can process the recipe and cause the data to be displayed on the display according to the recipe instructions.

### BACKGROUND OF THE INVENTION

1. Field of the Invention

This invention relates in general to devices having an electronic display and particularly, to handheld devices having a low-power mode.

2. Description of the Related Art

Power management has been, and continues to be, a major concern in the development and implementation of battery powered or battery operated microprocessor based systems, such as laptop computers, notebook computers, palmtop computers, personal data assistants (PDAs), hand-held communication devices, wireless telephones, and other devices, including units that are occasionally battery powered, but that also operate from a power line (AC) source. The need for power management is particularly acute for battery-operated single-chip microcomputer systems, where the desirability or requirement for overall reduction in physical size (and/or weight) also imposes severe limits on the size and capacity of the battery system, and yet where extending unit operating time without sacrificing performance is a competing requirement.

To conserve energy, many systems incorporate power-saving methods. One such method is to lower the operating frequency of the processing unit when there is no expected demand on the unit. This is effective because, in CMOS circuits, power consumption is a linear function of the clock frequency. This low-frequency/low-power mode is often called a “sleep” mode, indicating a resting state of the device when no demand is being placed on the processor. When a user indicates that device resources are needed, for example pressing a key, the unit “wakes up” and begins running again at the higher clock speed to enable processing at the fastest possible rate.

In addition to the competing needs for longer battery life and smaller package size, recent market trends illustrate a need for handheld devices that support features such as scrolling real-time stock quotes, news, sports scores, weather information, animations, and more. Prior-art devices with constantly updating screens require a processor and all support circuitry to be active for any updating to occur. That is, while the scrolling ticker with stock quotes, news, user customized messages, or any animation is running on any of the phone displays, the device cannot go into low-power mode because the main processor must be executing instructions to maintain the display information changing. This results in a significant impact to the phone operation and stand-by time, which results in the devices either not supporting the feature or suffering a significant impact on battery life.

Accordingly, a need exists for a handheld battery-operated device that can continuously update a display screen while in a low-power mode.

### SUMMARY OF THE INVENTION

The present invention concerns an electronic device with a display and a low-power operating mode. Provided on the device is a screen operable for displaying graphics and information, a memory for storing a “recipe” containing information, graphics, instruction commands regarding how the information and graphics are to be displayed. The device also includes a main processor, a high-frequency clock which runs the main processor while the device is in an “awake” mode, a low-frequency clock, a direct memory access controller (DMAC), which runs off of the low-frequency clock and can read the recipe information from the memory, and a display controller that writes to the display while the main processor is in a “sleep” mode.

The device receives display information via a wireless or preprogrammed on the device or a wired channel and stores the information in a memory location. As the device receives the data, if one does not already exist, it will build a recipe in memory which provides instructions to the device for displaying the information. For example, the recipe can dictate how long to illustrate a particular graphic, the speed of a scrolling graphic or piece of information, the color or size of a character, how long before repeating a cycle, and more. The recipe information can be manually input by a user or can be received at an input via a wireless or wired channel or the recipe information can be previously programmed on the device. Once the device receives the information and a recipe exists, the device can enter a “sleep” mode. While in sleep mode the processor either shuts down completely, or operates in a reduced power mode.

The DMAC runs from the low-frequency clock, thus consuming less power than the main processor when in “awake” or active mode, and is able to read the recipe and transfer data to a display controller along with instructions on how the data should be displayed. Alternatively, the display controller can execute the recipe commands while the DMAC is either operating from the low-frequency clock or is shut down completely.

The device periodically switches from sleep mode to awake mode, receives updated information via a wireless or wired channel or previously stored on the device, stores the information in the memory, and enters sleep mode for an additional period. In this manner, the device conserves energy and can realize a longer battery life while featuring a constantly updating display screen.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagram illustrating one embodiment of a handheld device and provider equipment within a radio communication system;

FIG. 2 is a block diagram illustrating a display and memory/buffer configuration;

FIG. 3 is block diagram illustrating a processor connected to a display controller and the display of FIG. 2, all located within the device shown in FIG. 1;

FIG. 4 is a block diagram illustrating a recipe;

FIG. 5 is a block diagram illustrating a Direct Memory Access Controller located within the device shown in FIG. 1;

FIG. 6 is block diagram illustrating a processor configuration within the device shown in FIG. 1;

FIG. 7 is a flow diagram illustrating a method of updating a display while the main processor is in low power mode.

FIG. 8 is a flow diagram illustrating a second method of updating a display while the main processor is in low power mode.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

Handheld Devices

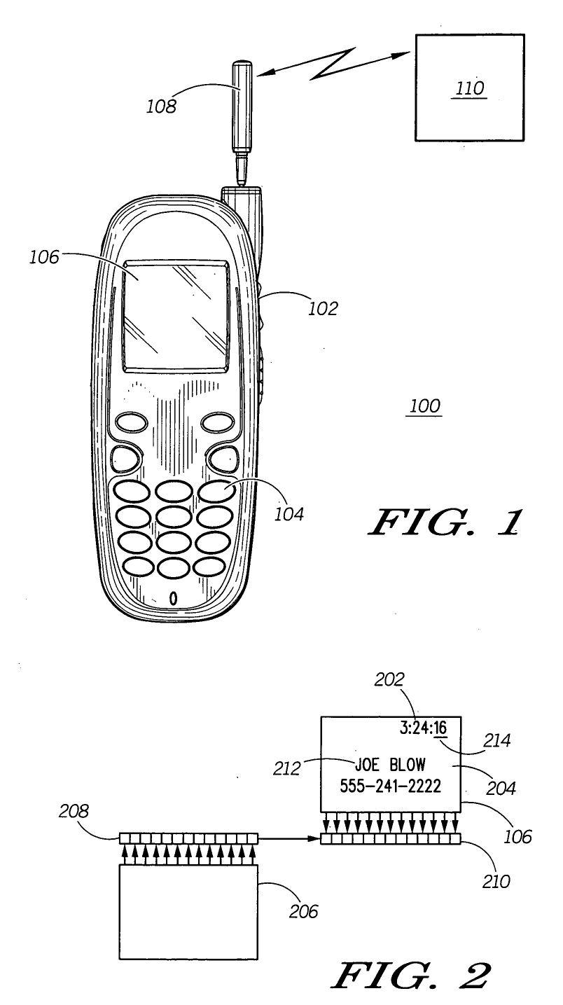

FIG. 1 shows one embodiment of a portable device 100. The particular portable device 100 shown in FIG. 1 is a wireless telephone capable of making and receiving wireless telephone calls within a radio communication system. Other wireless devices, which could also be used, include pagers, two-way radios, one-way radios, PDA's, Palmtops, portable computers, and more. The wireless portable device 100 of FIG. 1 includes a body 102 housing all of the components comprising the wireless portable device 100. The wireless portable 100 is provided with operating buttons 104, a display 106, and an antenna 108 for communicating with provider equipment 110 that manages communication services within the radio communication system. The operating buttons 104 are useful for entering information, such as telephone numbers, two-way radio private identifiers, names, and more, into the telephone. The information input by the number buttons 104 can be seen on the display 106.

The Display

The display 106 is shown in more detail in FIG. 2. The display 106 will be described as a Liquid Crystal Display (LCD), but the device is not so limited and other suitable display technologies, such as light emitting diode displays, for instance, can be implemented without departing from the spirit of the invention.

An LCD screen 106 is commonly used to display data and/or graphics generated by a data processing system. Displays, such as LCDs 106, often have drivers for selecting pixels located on two sides of the display. The two sided access allows the LCD to be scanned in a manner similar to the conventional Cathode Ray Tubes (CRTs) which provide pixel access starting from the upper left corner of the display and proceeding from left-to-right and from top-to-bottom. Using this scanning method, the data stored in a memory map (not shown) for the display is sequentially addressed. Thus, the bytes of data in the memory array are arranged as a digital representation of the data as it is visually viewed on the display 106.

A conventional Liquid Crystal Display (LCD) allows software programming of the display data 202, 212 that is encoded in bytes and stored in a graphics memory 206 such that the data is transferred to the display 106 in accordance with a visual conception of the data. For instance, a display that is two hundred and forty pixels wide may store the first thirty bytes in a line buffer 210. The data in the memory 206 is parallel loaded to a shift register 208 and serially shifted one data bit at a time to the line buffer 210 at the display. The line buffer circuitry (not shown) at the display 106 reassembles the serially shifted data which represents the data for the first line of the display. The thirty bytes stored in the line buffer 210 at the display are presented in parallel, thus affecting all the pixels for the first line. It is important to note that although the memory 206, shift register 208 and line buffer are shown as separate elements, in another embodiment, one or more of these elements are integrated together to achieve the same result.

The refresh rate can be variably set depending on the information that is to be shown on the display. For instance, a digital representation of the time 202 on the screen 204 needs to be updated once every second to change the numbers 214 representing the seconds. A moving graphic, on the other hand, such as a bouncing ball, may need to be updated several times a second to give the appearance of motion. The information to be displayed and the rate of screen update is dictated by a display controller.

The Display Controller

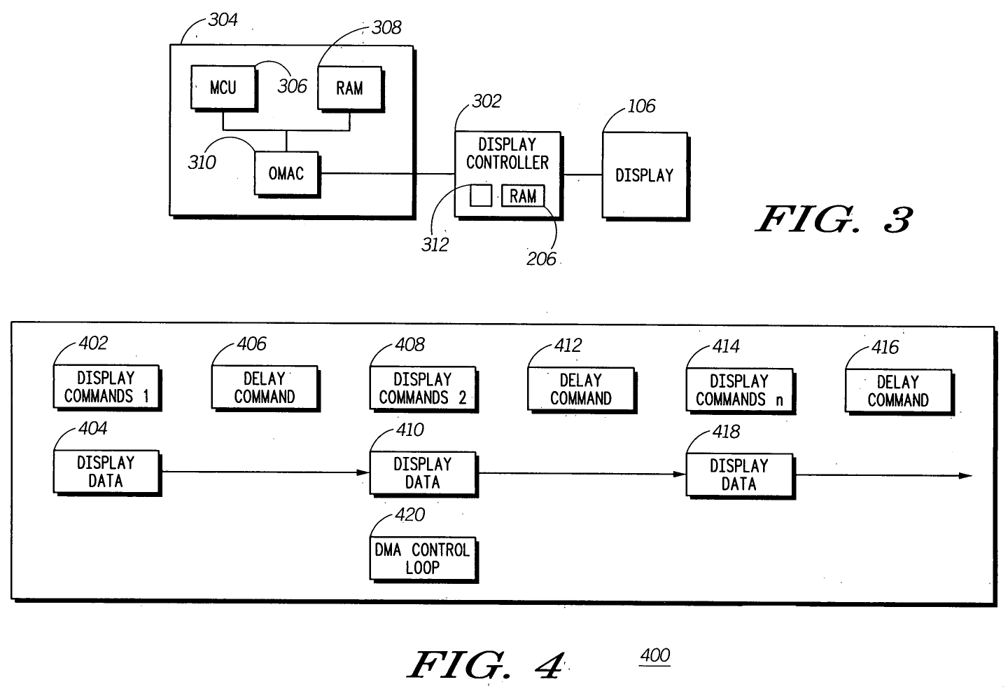

A display controller is typically used for interfacing a display screen to a data processing system. Looking now to FIG. 3, the display 106 is shown connected to a display controller 302, which includes a Random Access Memory (RAM) 206. The LCD controller 302 reads data, as well as instructions, from the RAM 206 and is able to process the instructions provided in the RAM 206 and move the data to the display 106, where it is displayed according to the instructions. The display controller 302 is provided with a controller clock 312.

The Recipe

The instructions and data contained in the RAM 206 is referred to as a “recipe” and is shown in FIG. 4. The recipe 400 defines, among other things, which data is to be displayed, how long it is to be displayed, what data replaces it, and how long before data is to be displayed again. The sample recipe format illustrated in FIG. 4 shows, chronologically, how the recipe commands work with one another.

A first display command 402 is read by the display controller 302 along with a set of data 404 to be displayed. A delay command 406 tells the controller how long to display the first set of data 404. At the end of the time defined by the first delay command 406, the controller 302 reads the second display command 408 along with the data 410 to be displayed according to the display command 408. A second delay command 412 tells the controller how long to display the second set of data 410. The controller continues to read the data as just described until it reaches the nth command 414 nth delay instruction 416, and nth data set 418. A display control loop 420 defines whether and/or how long until the controller should execute the recipe loop again. In this way, the display 106 can be continuously updated, allowing information and/or graphics to be displayed in a static or dynamic presentation. It is important to note that the display commands 402, 408, 414 can be composed of a variety of well known graphics commands such as display text, display graphic, scroll, shift left, shift right, shift up, shift down, move to location where each of these graphics commands includes zero or more variables. For instance, the move command in one embodiment includes X-Y display coordinates of desired destination on the screen. Likewise, the delay command in one embodiment includes a variable for the number of milliseconds necessary for the delay. Using fundamental graphic commands, the recipe is able to control a wide variety of screen animations.

DMAC

Direct Memory Access (DMA) is where a set of data is transferred into a set of memory locations, under the control of a DMA controller (DMAC), without requiring active intervention from the central processing unit (CPU) of a host computer. The CPU is the part of a computer that interprets and carries out the instructions contained in the software. In most CPUs, this task is divided between a control unit that directs program flow and one or more execution units that perform operations on data. Almost always, a collection of registers is included to hold operands and intermediate results. The term CPU is often used vaguely to include other centrally important parts of a computer such as caches and input/output controllers, especially in computers with modem microprocessor chips that include several of these functions in one physical integrated circuit used to handle the task of moving data to and from the memory of a computer.

Tasks can be fairly complex and require logic to be applied to the data to convert formats and other similar duties. In these situations the computer's CPU would normally be asked to handle the logic, but due to the fact that the I/O devices are very slow, the CPU would end up spending a huge amount of time (in computer terms) sitting idle waiting for the data from the device.

A DMAC avoids this problem by using a low-cost CPU with enough logic and memory onboard to handle these sorts of tasks. They are typically not powerful or flexible enough to be used on their own, and are actually a form of co-processor. A co-processor is a secondary processor in a computer that handles tasks that the general-purpose CPU either cannot implement, or does not implement for efficiency reasons. This is distinct from the term multiprocessor, which refers to a computer with more than one general-purpose CPU.

Referring again to FIG. 3, it can be seen that the display controller 302 is connected to a main processor 304. A first processor or main processor 304 includes a microprocessor 306, a Random Access Memory (RAM) 308, and second processor such as a Direct Memory Access Controller (DMAC) 310. In order for a DMA transmission to occur, a series of instructions is sent from the microprocessor 306 to the DMAC 310 for transmitting data from a specific memory, i.e., a source memory, to another memory, i.e., a destination memory. The DMAC then executes the instructions. It is important to note that in another embodiment, display controller 302 may reside in main processor 304 such as an embedded baseband processor.

A conventional DMAC device 310, shown in FIG. 5, is comprised of a count register 502 for storing the number of DMA transmissions which should be carried out, a control register 504 for storing an instruction issued from the microprocessor (not shown), a source address generator 506 for generating the address of a source memory which stores data to be transmitted, a destination address generator 508 for generating the address of a destination memory in which the data transmitted from the source memory is transferred to, a state register 512 for storing a state occurring during DMA transmission. All of the components of DMAC 310 are controlled by a microengine 510 which acts analogously to an arithmetic logic unit in a general purpose processor as understood to those of average skill in the DMAC field.

The DMAC 310 fills the line buffer 510 with display data from the system memory 308 in bursts of a predetermined number of words. Once the data is in the line buffer 510, it can be written to the memory 310 within the display controller 302, or the display controller 302 can read it directly from the line buffer 510 and immediately refresh the screen with the data.

In another embodiment, a recipe 400 to be executed. The first method is as described in the preceding paragraphs describing the display controller 302. The second method is for the DMAC 310 to process the recipe 400 and to load data into its line buffer according to the recipe instructions. If each time the data is loaded, the display controller 302 is notified so that an upload occurs to the display 106, the recipe can be followed. Regardless of which method is chosen, it may be desirable for the recipe 400 to be periodically updated.

MCU

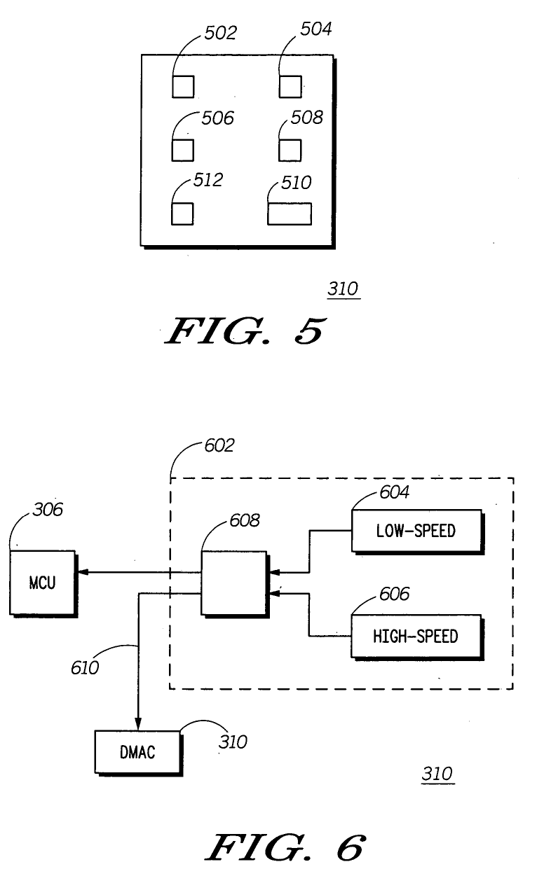

Looking now to FIG. 6, it can be seen that the microprocessor (MCU) 306 runs on an operating clock supplied from an oscillation circuit 602. The oscillation circuit 602 comprises a low-speed oscillation circuit 604 for a low-speed mode that outputs a low-speed clock, a high-speed oscillation circuit 606 for a high-speed mode that outputs a high-speed clock, and an MCU clock controller 608 that selects either the low-speed clock or the high-speed clock and supplies it to the MCU 306. It is important to note that in another embodiment low-speed oscillation circuit 604 and high speed oscillation circuit can be the same circuit.

When the MCU 306 is operating in high-speed mode, a first clock signal corresponding to the high-speed clock 606 is selected, when it is operating in low-speed mode, the low-speed clock 604 is selected. In this manner, the configuration is such that the internal power supply potential during operation in low-speed mode is lower than that during operation in high-speed mode, enabling a reduction of the voltage and thus enabling a much lower rate of power consumption within the device.

Sleep Mode

When operation of the MCU 306 is not needed, the MCU clock controller 508 switches so that only a second clock signal corresponding to the low-speed clock signal is input to the MCU 306. External circuits can be provided to monitor the MCU 306 to determine whether sleep mode is appropriate, or the MCU itself can monitor its demand and usage and request that the low speed clock signal be input to the MCU. While in the sleep mode, the MCU 306 uses 10 to 100 times less power compared to full-clock-rate mode. Additionally, the MCU 306 can be shut down completely during sleep mode to realize an even greater reduction in power consumption.

While in sleep mode, the DMAC 310 can also be driven by the low-speed clock signal to conserve power. The DMAC 310 is selected so that it functions as described in the preceding paragraphs, even at a clock rate slower than the high-speed clock rate. FIG. 6 shows a second output 610 from the MCU clock controller 608. The second output 610 supplies a clock signal to the DMAC 310. However, the DMAC 310 does not have to run at the same speed as the MCU 306 and can receive its clocking from a separate oscillator.

The display controller 302 is not affected by the MCU clock controller 608 and continues to execute instructions at its supplied clock rate 312 even when the device is in sleep mode.

### CONCLUSION

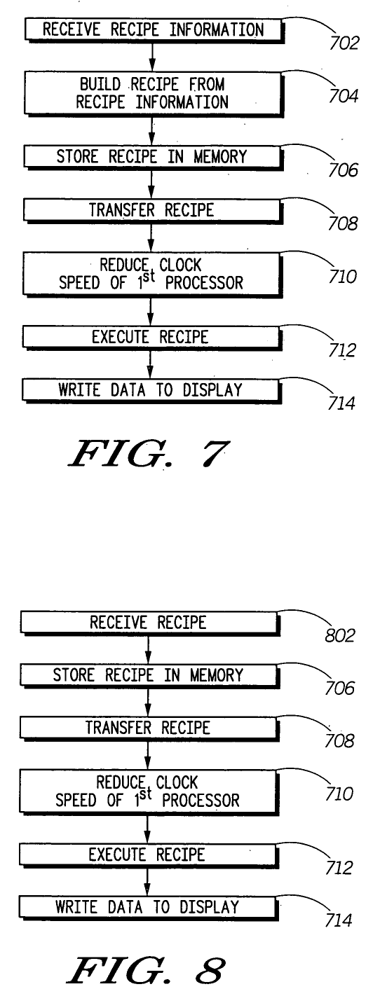

With the configuration just described, the MCU 306 can switch to low-power mode while the DMAC 310 remains active to facilitate updating the display 106. In this manner, as is shown in the flow chart of FIG. 7, the device receives recipe information 702, builds a recipe 704 based on the information, stores the data 706, via the MCU 306, in a provided internal memory 308, transmits the recipe 708 to the DMAC 310, and switches the MCU 306 to low-power mode 710. The DMAC 310 then independently follows the recipe information 712 to transfer data, according the recipe, to the display controller 302, 314, which then updates the display 106, 714.

In one alternative embodiment, in step 708, the DMAC 310 transfers the recipe to a display controller 302, which then executes the recipe instructions 400 to display information to the display 106. While the display controller 302 executes the instructions 400, the DMAC 310 and MCU 306 can either run from the low-speed clock signal 604 or shut down completely to reduce overall power consumption of the portable device 100.

In yet another alternative embodiment, shown in the flow chart of FIG. 8, the device receives a complete recipe in step 802, and stores the recipe in memory in step 706. The process continues as shown in FIG. 7 and described above. With the method shown in FIG. 8 the time and resources necessary for building a recipe is eliminated.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A portable device comprising:
at least one display operable for displaying information;
a first processor;
a second processor;
at least one oscillator producing a first clock signal and a second clock signal with a lower frequency than the first clock signal; and
a recipe, including at least one of a display command and a delay command for writing to the display;
wherein the second processor executes the recipe commands while the first processor is operating at the lower frequency provided by the second clock signal.

2. The portable device according to claim 1, wherein the second processor comprises a Direct Memory Access Controller.

3. The portable device according to the claim 1, wherein the second processor comprises a Display Controller.

4. The portable device according to claim 3, wherein the recipe is stored in a memory located within the Display Controller.

5. The portable device according to claim 1, wherein the recipe is stored in a memory accessible to both the first processor and the second processor.

6. The portable device according to claim 1, further comprising:
the second processor executing the recipe commands independent of the first processor.

7. The portable device according to claim 1, wherein the recipe further comprises:
display data; and
loop control commands.

8. The portable device according to claim 1, further comprising:
an input for receiving recipe information.

9. The portable device according to claim 8, wherein the input comprises:
a wireless receiver.

10. The portable device according to claim 8, wherein the first processor creates and stores in a memory, the recipe, based on the received recipe information.

11. The portable device according to claim 1, further comprising:
an oscillating frequency of the second clock signal is zero.

12. The portable device according to claim 1, wherein the information for displaying on the display includes at least one of text and graphics.

13. The portable device according to claim 1, wherein the portable device is selected from a group of portable devices consisting of laptop computers, notebook computers, palmtop computers, personal data assistants (PDAs), hand-held communication devices, and wireless telephones.

14. A method for updating a display in a portable device, the method comprising:
receiving recipe information, the recipe information including at least one of a display command, a delay command, display data, and a loop control command;
building with a first processor, a recipe based on the recipe information;
storing the recipe in a memory;
reducing a clock speed of the first processor;
executing the recipe with a second processor, independent of the first processor; and
writing display data to a display in accordance with the recipe.

15. The method according to claim 14, wherein the second processor comprises a Direct Memory Access Controller.

16. The method according to claim 14, wherein the second processor comprises a Display Controller.

17. The wireless device according to claim 16, wherein the memory is located within the Display Controller.

18. The method according to claim 14, further comprising:
receiving the recipe information with a wireless receiver.

19. A method for updating a display in a wireless device, the method comprising:
receiving a recipe, the recipe including at least one of a display command, a delay command, display data, and a loop control command;
storing the recipe in a memory;
reducing a clock speed of a first processor;
executing the recipe with a second processor, independent of the first processor; and
writing display data to a display.

20. The method according to claim 19, wherein the second processor comprises:
a Direct Memory Access Controller.

21. The method according to claim 19, wherein the second processor comprises:
a Display Controller.

22. The method according to claim 21, wherein the memory is located within the Display Controller.

23. The method according to claim 19, further comprising:
receiving the recipe information with a wireless receiver.
